(19) United States
(12) Patent Application Publication
(10) Pub. No.: US 2026/0359187 A1
(43) Pub. Date: Nov. 12, 2026

(54) SYSTEM AND METHOD FOR AI PIPELINE PERFORMANCE EVALUATION AND IMPROVEMENT

(71) Applicant: Wix.com Ltd., Tel Aviv (IL)

(72) Inventors: Dvir Eliezer COHEN, Mazkeret Batya (IL); Lin BURG, Tel Aviv (IL)

(21) Appl. No.: 19/673,302

(22) Filed: May 11, 2026

Related U.S. Application Data
(60) Provisional application No. 63/803,811, filed on May 11, 2025.

(51) Int. Cl. G06F 11/34; G06F 9/48; G06F 11/30

(52) U.S. Cl. CPC G06F 11/3433; G06F 9/4881; G06F 11/3017; G06F 11/3065

(57) ABSTRACT

A computer-implemented method evaluates a performance of a multi-stage AI pipeline having a plurality of AI pipeline interaction components. The method generates a collection of evaluation outputs, where one or more of the outputs include a quantitative feedback and a qualitative feedback. The quantitative feedback from the evaluation outputs is aggregated to generate at least one aggregated metric score for the AI pipeline. A natural language insight report is then compiled based on the corresponding at least one aggregated metric score and the qualitative feedback of the evaluation outputs. Finally, a set of actionable recommendations is provided based on a holistic analysis of the natural language insight reports.

### CROSS REFERENCE TO RELATED APPLICATIONS

This application claims priority from U.S. provisional patent application 63/803,811, filed 11 May 2025 which is incorporated herein by reference.

### FIELD OF THE DISCLOSURE

Embodiments of the present disclosure relate generally to explainable evaluation frameworks for multi-stage artificial intelligence pipelines and to explainable evaluation frameworks for Retrieval-Augmented Generation (RAG) systems in particular.

### BACKGROUND OF THE DISCLOSURE

A multi-stage AI pipeline refers to a modular architectural design where a complex task is decomposed into a sequence of distinct, interconnected interaction components. In this framework, the output of one stage serves as the direct input for the subsequent stage. This sequential processing allows for specialized optimization at every step, making it a standard technical approach in sophisticated applications.

The complexity of these multi-stage AI pipelines necessitates the use of evaluation frameworks to assess system performance. Such frameworks are designed to provide quantitative assessments, often in the form of numerical scores, that measure the quality of the pipeline's output. As these AI systems become more sophisticated and are deployed in various domains, the interpretability of their evaluation results is also a field of interest, aiming to provide a clear understanding of system behavior.

One prominent example of a multi-stage pipeline is a Retrieval-Augmented Generation (RAG) system. RAG systems have emerged as a promising approach in natural language processing, combining the strengths of large language models with external knowledge retrieval. These systems aim to produce more factual, relevant, and contextually grounded outputs by integrating retrieved information into the generation process. RAG has shown potential in various applications, including question answering, information retrieval, and content generation. The quality of a RAG system's final output depends on multiple factors, including the relevance of the retrieved information and the faithfulness of the generated text to the retrieved context. As RAG systems have become more prevalent, various evaluation methods have been developed.

### SUMMARY OF THE PRESENT DISCLOSURE

There is therefore provided, in accordance with an embodiment of the present disclosure, a computer-implemented method for evaluating a performance of a multi-stage AI pipeline having a plurality of AI pipeline interaction components, the method including generating a collection of evaluation outputs, one or more of which including a quantitative feedback and a qualitative feedback, aggregating the quantitative feedback from the evaluation outputs to generate at least one aggregated metric score for the AI pipeline, and compiling a natural language insight report based on the corresponding at least one aggregated metric score and the qualitative feedback of the evaluation outputs, and providing a set of actionable recommendations based on a holistic analysis of the natural language insight reports.

Moreover, in accordance with an embodiment of the present disclosure, where generating a collection of evaluation outputs includes generating, for a plurality of records in a dataset, where a given record corresponds to an interaction involving one or more of the AI pipeline interaction components, a respective set of evaluation outputs based on a plurality of predefined AI pipeline evaluation metrics.

Further, in accordance with an embodiment of the present disclosure, where the holistic analysis includes identifying a systemic behavior of the AI pipeline.

Still further, in accordance with an embodiment of the present disclosure, the method further includes prioritizing the set of actionable recommendations based on an impact on system performance, the impact on system performance including at least a high impact level and a medium impact level.

Additionally, in accordance with an embodiment of the present disclosure, where the multi-stage AI pipeline is a RAG (Retrieval-Augmented Generation) pipeline, and where the AI pipeline interaction components include, a user input, a retrieved context, and a generated answer.

Moreover, in accordance with an embodiment of the present disclosure, where the multi-stage AI pipeline is a RAG (Retrieval-Augmented Generation) pipeline, and where a plurality of predefined RAG evaluation metrics is selected such that, at least one metric evaluates a property of the generated answer relative to the user input, and at least one metric evaluates a property of the retrieved context relative to the user input.

Further, in accordance with an embodiment of the present disclosure, where the multi-stage AI pipeline is a RAG (Retrieval-Augmented Generation) pipeline, and where the plurality of AI pipeline evaluation metrics is selected from the group consisting of, context relevancy, answer relevancy, context adherence, and grading note.

Still further, in accordance with an embodiment of the present disclosure, where the multi-stage AI pipeline is a RAG (Retrieval-Augmented Generation) pipeline, and where the AI pipeline interaction components further include a ground truth answer, and where at least one of the AI pipeline evaluation metrics evaluates a property of the generated answer relative to the ground truth answer or a property of the retrieved context relative to the ground truth answer.

Additionally, in accordance with an embodiment of the present disclosure, where the multi-stage AI pipeline is a RAG (Retrieval-Augmented Generation) pipeline, and where the AI pipeline interaction components further include a ground truth answer, and where at least one of the AI pipeline evaluation metrics is selected from the group further consisting of, context recall and factuality.

Moreover, in accordance with an embodiment of the present disclosure, where the multi-stage AI pipeline is a RAG (Retrieval-Augmented Generation) pipeline, and where the AI pipeline interaction components further include a ground truth answer, and where the plurality of AI pipeline evaluation metrics is selected from the group consisting of, context relevancy, context recall, answer relevancy, factuality, context adherence, and grading note.

Further, in accordance with an embodiment of the present disclosure, where the plurality of predefined AI pipeline evaluation metrics is configured to evaluate a relationship between at least two of the AI pipeline interaction components.

Still further, in accordance with an embodiment of the present disclosure, where generating the evaluation outputs, compiling the natural language insight reports, and providing the set of structured, actionable recommendations are performed using one or more processors configured to communicate with one or more large language models (LLMs) to perform one or more of, generate the evaluation outputs by causing a first LLM to process input data, compile the natural language insight reports by causing a second LLM to generate natural language text based on the evaluation outputs, and provide the set of actionable recommendations by causing a third LLM to generate recommendations based on the natural language insight reports.

Additionally, in accordance with an embodiment of the present disclosure, where the second LLM is a specialized reasoning LLM.

Moreover, in accordance with an embodiment of the present disclosure, where the third LLM is a reasoning LLM.

Further, in accordance with an embodiment of the present disclosure, where the at least one aggregated metric score is selected from the group consisting of, a mean score, a standard deviation, and an identification of one or more outlier records.

Still further, in accordance with an embodiment of the present disclosure, where each of the actionable recommendations includes a plurality of predefined sections, the sections including, (i) a title for the recommendation, (ii) an explanation of the identified systemic behavior, (iii) an illustrative example selected from the dataset, and (iv) one or more steps for remediation.

Additionally, in accordance with an embodiment of the present disclosure, where the explanation of the identified systemic behavior includes a description of what is wrong with the AI pipeline's performance and a hypothesis for why it happened.

Moreover, in accordance with an embodiment of the present disclosure, where the multi-stage AI pipeline is a RAG (Retrieval-Augmented Generation) pipeline, and where the one or more steps for remediation include specific, contextual advice formulated based on the holistic analysis, the advice including at least one of, a modification to a retrieval parameter or a modification to a generation prompt.

Further, in accordance with an embodiment of the present disclosure, where the step of generating the collection of evaluation outputs further includes, performing the generation of the corresponding evaluation output for the plurality of records in parallel.

Still further, in accordance with an embodiment of the present disclosure, where the holistic analysis further includes proposing a modification to a configuration parameter of the multi stage AI pipeline and the method further includes automatically parsing the at least one recommendation to identify the proposed modification to the configuration parameter, and programmatically modifying the configuration parameter of the multi-stage AI pipeline based on the identified modification, thereby creating a modified multi-stage AI pipeline.

Additionally, in accordance with an embodiment of the present disclosure, where the multi-stage AI pipeline is a RAG (Retrieval-Augmented Generation) pipeline, and where the configuration parameter includes a retrieval parameter (‘k’).

Moreover, in accordance with an embodiment of the present disclosure, the method further includes, for at least a subset of the plurality of records, receiving a second collection of evaluation outputs, where each evaluation output in the second collection is human-generated, determining an alignment score by comparing the evaluation outputs generated for the subset of records with the second collection of evaluation outputs, and generating a third collection of evaluation outputs, where each evaluation output in the third collection includes the evaluation output of the first collection if the alignment score is above a predetermined threshold, and includes the corresponding human-generated evaluation output otherwise, where the aggregation, compiling and providing operations are performed based on the third collection of evaluation outputs.

There is therefore provided, in accordance with an embodiment of the present disclosure, a system for evaluating a performance of a multi-stage AI pipeline. The system includes a metric calculator, an insight generator, and an action recommender. The metric calculator is configured to generate a collection of evaluation outputs, one or more of which includes a quantitative feedback and a qualitative feedback for a plurality of predefined AI pipeline evaluation metrics. The insight generator is configured to, for the plurality of predefined AI pipeline evaluation metrics, (i) generate at least one aggregated metric score and (ii) compile a natural language insight report. The action recommender is configured to provide a set of actionable recommendations based on a holistic analysis of the natural language insight reports.

Further, in accordance with an embodiment of the present disclosure, where the metric calculator is configured to generate evaluation outputs for AI pipeline evaluation metrics that evaluate a relationship between at least two of a plurality of AI pipeline interaction components involved in an interaction corresponding to a given record.

Still further, in accordance with an embodiment of the present disclosure, where the multi-stage AI pipeline is a RAG (Retrieval-Augmented Generation) pipeline, and where the AI pipeline interaction components include, a user input, a retrieved context, and a generated answer.

Additionally, in accordance with an embodiment of the present disclosure, where the plurality of predefined RAG evaluation metrics is selected such that, at least one metric evaluates a property of the generated answer relative to the user input, and at least one metric evaluates a property of the retrieved context relative to the user input.

Moreover, in accordance with an embodiment of the present disclosure, where the plurality of AI pipeline evaluation metrics are selected from the group consisting of, context relevancy, answer relevancy, context adherence, and grading note.

Further, in accordance with an embodiment of the present disclosure, where the AI pipeline interaction components further include a ground truth answer, and where at least one of the AI pipeline evaluation metrics evaluates a property of the generated answer relative to the ground truth answer or a property of the retrieved context relative to the ground truth answer.

Still further, in accordance with an embodiment of the present disclosure, where the AI pipeline interaction components further include a ground truth answer, and where at least one of the AI pipeline evaluation metrics is selected from the group further consisting of, factuality, and context recall.

Additionally, in accordance with an embodiment of the present disclosure, where the AI pipeline interaction components further include a ground truth answer, and where the plurality of AI pipeline evaluation metrics are selected from the group consisting of, context relevancy, context recall, answer relevancy, factuality, context adherence, and grading note.

Moreover, in accordance with an embodiment of the present disclosure, where one or more of the metric calculator, the insight generator, and the action recommender are communicatively coupled to one or more large language models and where (1) the metric calculator is further configured to cause a first large language model (LLM) to generate the evaluation outputs, (2) the insight generator is further configured to cause a second LLM to compile the natural language insight reports or (3) the action recommender is further configured to cause a third LLM to provide the set of actionable recommendations.

Further, in accordance with an embodiment of the present disclosure, where the second LLM is a specialized reasoning LLM.

Still further, in accordance with an embodiment of the present disclosure, where the third LLM is a reasoning LLM.

Additionally, in accordance with an embodiment of the present disclosure, where the at least one aggregated metric score is selected from the group consisting of, a mean score, a standard deviation, and an identification of one or more outlier records.

Moreover, in accordance with an embodiment of the present disclosure, the system further includes an action prioritizer configured to prioritize the set of actionable recommendations based on an impact on system performance, the impact on system performance including at least a high impact level and a medium impact level.

Further, in accordance with an embodiment of the present disclosure, where the action recommender is further configured to identifying a systemic behavior of the AI pipeline.

Still further, in accordance with an embodiment of the present disclosure, where each of the actionable recommendations includes a plurality of predefined sections, the sections including, (i) a title for the recommendation, (ii) an explanation of the identified systemic behavior, (iii) an illustrative example selected from the dataset, and (iv) one or more steps for remediation.

Additionally, in accordance with an embodiment of the present disclosure, where the explanation of the identified systemic behavior includes a description of what is wrong with the RAG system's performance and a hypothesis for why it happened.

Moreover, in accordance with an embodiment of the present disclosure, where the one or more steps for remediation include specific, contextual advice formulated based on the holistic analysis, the advice including at least one of, a modification to a retrieval parameter or a modification to a generation prompt.

Further, in accordance with an embodiment of the present disclosure, where the metric calculator is further configured to generate the collection of evaluation outputs for the plurality of records in parallel.

Still further, in accordance with an embodiment of the present disclosure, where the holistic analysis further includes proposing a modification to a configuration parameter of the multi stage AI pipeline and the system further includes a recommendation parser and a configuration modifier. The recommendation parser is configured to automatically parse the at least one recommendation to identify the proposed modification to the configuration parameter. The configuration modifier is configured to programmatically modify the configuration parameter of the multi-stage AI pipeline based on the identified modification, thereby creating a modified multi-stage AI pipeline.

Additionally, in accordance with an embodiment of the present disclosure, where the multi-stage AI pipeline is a RAG (Retrieval-Augmented Generation) pipeline, and where the configuration parameter includes a retrieval parameter (‘k’).

Moreover, in accordance with an embodiment of the present disclosure, the computer executable components further include a data input module, an alignment calculator, and a metric updater. The data input module is configured to receive, for at least a subset of the plurality of records, a second collection of evaluation outputs, where each evaluation output in the second collection is human-generated. The alignment calculator is configured to determine an alignment score by comparing the evaluation outputs generated by the metric calculator for the subset of records with the second collection of evaluation outputs. The metric updater is configured to generate a third collection of evaluation outputs, where each evaluation output in the third collection includes the evaluation output generated by the metric calculator if the alignment score is above a predetermined threshold, and includes the corresponding human-generated evaluation output otherwise, where the insight generator and the action recommender operate based on the third collection of evaluation outputs.

There is therefore provided, in accordance with an embodiment of the present disclosure, a computer-implemented method for validating an automated evaluation system for multi-stage AI pipelines, the method including generating, by the automated evaluation system for a subset of records from a dataset, a first set of evaluation outputs, where a given evaluation output of the first set includes an automatically generated quantitative feedback and an automatically generated qualitative feedback, receiving a second set of evaluation outputs for the same subset of records, where a given evaluation output of the second set includes a human-generated quantitative feedback and a human-generated qualitative feedback, and determining an alignment score between the automated evaluation system and human judgment by comparing the first set of evaluation outputs with the second set of evaluation outputs.

Further, in accordance with an embodiment of the present disclosure, where the multi-stage AI pipeline is a RAG (Retrieval-Augmented Generation) pipeline.

There is therefore provided, in accordance with an embodiment of the present disclosure, a system for validating an automated evaluation system for multi-stage AI pipelines. The system includes a metric calculator, a data input module, and an alignment calculator. The metric calculator is configured to generate, for a subset of records from a dataset, a first set of evaluation outputs, where a given evaluation output of the first set includes an automatically generated quantitative feedback and an automatically generated qualitative feedback. The data input module is configured to receive a second set of evaluation outputs for the same subset of records, where a given evaluation output of the second set includes a human-generated quantitative feedback and a human-generated qualitative feedback. The alignment calculator is configured to determine an alignment score between the automated evaluation system and human judgment by comparing the first set of evaluation outputs with the second set of evaluation outputs.

Still further, in accordance with an embodiment of the present disclosure, where the automated evaluation system is configured for evaluating a RAG (Retrieval-Augmented Generation) pipeline.

There is therefore provided, in accordance with an embodiment of the present disclosure, a computer program product facilitating performance evaluation of a multi-stage AI pipeline, the computer program product including a computer readable storage medium having program instructions embodied therewith, the program instructions executable by a processor to cause the processor to generate a collection of evaluation outputs, one or more of which includes a quantitative feedback and a qualitative feedback for a plurality of predefined AI pipeline evaluation metrics, aggregate the quantitative feedback from the evaluation outputs to generate at least one aggregated metric score for the AI pipeline, and compile a natural language insight report based on the corresponding at least one aggregated metric score and the qualitative feedback from the evaluation outputs, and provide a set of actionable recommendations based on a holistic analysis of the natural language insight reports.

There is therefore provided, in accordance with an embodiment of the present disclosure, a computer program product facilitating validation of an automated evaluation system for multi-stage AI pipelines, the computer program product including a computer readable storage medium having program instructions embodied therewith, the program instructions executable by a processor to cause the processor to generate, by the automated evaluation system for a subset of records from a dataset, a first set of evaluation outputs, where a given evaluation output of the first set includes an automatically generated quantitative feedback and an automatically generated qualitative feedback, receive a second set of evaluation outputs for the same subset of records, where a given evaluation output of the second set includes a human-generated quantitative feedback and a human-generated qualitative feedback, and determine an alignment score between the automated evaluation system and human judgment by comparing the first set of evaluation outputs with the second set of evaluation outputs.

### BRIEF DESCRIPTION OF THE DRAWINGS

The subject matter regarded as the disclosure is particularly pointed out and distinctly claimed in the concluding portion of the specification. The disclosure, however, both as to organization and method of operation, together with objects, features, and advantages thereof, may best be understood by reference to the following detailed description when read with the accompanying drawings in which:

FIG. 1A is a block diagram illustration of an exemplary environment for the explainable evaluation of multi-stage AI pipelines, constructed and operative in accordance with some embodiments of the present disclosure;

FIG. 1B is a data flow diagram illustration of the operational stages of the AI pipeline evaluation system of FIG. 1A, constructed and operative in accordance with some embodiments of the present disclosure;

FIG. 2A is a flowchart illustration of a method for evaluating a performance of a multi-stage AI pipeline, constructed and operative in accordance with some embodiments of the present disclosure;

FIG. 2B is a block diagram illustration of an AI pipeline evaluation system, constructed and operative in accordance with some embodiments of the present disclosure;

FIG. 3A is a data flow diagram illustration of an exemplary process for evaluating a Retrieval-Augmented Generation (RAG) pipeline, constructed and operative in accordance with some embodiments of the present disclosure;

FIG. 3B is a conceptual diagram illustration of a “metric diamond” for evaluating a RAG pipeline, in accordance with some embodiments of the present disclosure;

FIG. 3C is an illustration of a plurality of confusion matrices depicting inter-labeler correlations for a plurality of evaluation metrics, in accordance with some embodiments of the present disclosure;

FIG. 3D is a table illustration showing a quantitative summary of the alignment between LLM-based metric scores and human preferences, in accordance with some embodiments of the present disclosure;

FIG. 3E is a table illustration summarizing the performance of a RAG pipeline before and after incorporating improvements, in accordance with some embodiments of the present disclosure;

FIG. 4A is a flowchart illustration of a method for evaluating the performance of a RAG pipeline, constructed and operative in accordance with some embodiments of the present disclosure;

FIG. 4B is a block diagram illustration of an AI pipeline evaluation system configured for evaluating a RAG pipeline, constructed and operative in accordance with some embodiments of the present disclosure;

FIG. 5A is a flowchart illustration detailing a modification process for a general multi-stage AI pipeline, constructed and operative in accordance with some embodiments of the present disclosure;

FIG. 5B is a flowchart illustration detailing a modification process for a RAG pipeline, constructed and operative in accordance with some embodiments of the present disclosure;

FIG. 5C is a block diagram illustration of elements that may execute a modification process, constructed and operative in accordance with some embodiments of the present disclosure;

FIG. 6A is a flowchart illustration of a method for validating an automated evaluation system for multi-stage AI pipelines, constructed and operative in accordance with some embodiments of the present disclosure; and

FIG. 6B is a block diagram illustration of a validation system for a multi-stage AI pipeline evaluation system, constructed and operative in accordance with some embodiments of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT DISCLOSURE

In the following detailed description, numerous specific details are set forth in order to provide a thorough understanding of the disclosure. However, it will be understood by those skilled in the art that the present disclosure may be practiced without these specific details. In other instances, well-known methods, procedures, and elements have not been described in detail so as not to obscure the present disclosure.

Applicant has realized that existing evaluation frameworks for AI pipelines are ill-equipped to assess the performance of complex, multi-stage AI pipelines. In such systems, where an input is processed through a series of distinct computational stages to produce a final output, errors can originate in any stage and compound in subsequent stages. This interplay between different stages leads to unexpected behaviors and makes it difficult to diagnose the root cause of a final error. The prior art lacks methods for systematically isolating which stage of a complex AI pipeline is responsible for a performance deficiency.

Applicant has realized that Retrieval-Augmented Generation (RAG) systems are a primary example of such a multi-stage AI pipeline and therefore acutely reflect these evaluation challenges. A RAG system comprises at least a retrieval stage, configured to find relevant context from a knowledge base, and a generation stage, configured to synthesize an answer based on that context. The quality of the final generated answer therefore depends on the successful operation of both distinct stages, and a failure in either stage can lead to a poor final output.

Applicant has realized that traditional evaluation metrics for RAG systems provide an incomplete and often misleading assessment of system performance. Existing approaches often provide abstract numerical scores without detailed explanations or actionable insights. This lack of interpretability makes it challenging for developers and researchers to identify specific areas for improvement or understand the root causes of performance issues. For example, a low “factuality” score does not, by itself, indicate whether the system failed to retrieve the correct facts in the retrieval stage or retrieved the correct facts but failed to adhere to them in the generation stage.

Applicant has realized that a system that can distinguish between different failure modes, such as poor context retrieval versus a failure to adhere to context, or factual inaccuracies in generation, and can pinpoint the specific part of the pipeline—retrieval versus generation—that is causing the failure, can provide an explanation in a language that even non-experts can understand. Such a system may help non-experts know how to improve their AI pipelines (e.g., RAG pipelines). By translating complex technical assessments into clear explanations and actionable recommendations, such a system can empower a wider range of users, including product managers and domain experts, to participate in the system improvement process, thereby building trust and facilitating the adoption of complex AI systems in high-stakes domains.

The present disclosure provides a holistic, interpretable, and actionable assessment of multi-stage AI pipeline performance, addressing the significant gap in existing evaluation methodologies. To overcome the challenge of opaque numerical scores, the present disclosure describes a framework that integrates quantitative and qualitative analysis into a cohesive system. For each evaluation metric, the disclosed system generates not just a numerical score, but also a corresponding qualitative, human-readable textual rationale that explains the reasoning behind the score. This provides a transparent view into the system's performance on a granular level.

To address the difficulty of diagnosing which stage of a complex pipeline is failing, the present disclosure describes a multi-level analysis process. The framework first synthesizes the granular scores and their textual rationales into high-level, natural language insight reports on a per-metric basis. By evaluating metrics that target specific relationships within interaction components of the pipeline—such as the relationship between retrieved context and a generated answer—these insights help to isolate failures to a specific stage, such as retrieval versus generation.

Furthermore, to provide clear and actionable guidance, the present disclosure describes a system that performs a holistic analysis of these individual insight reports. By evaluating the interplay between different insights, the system can diagnose systemic failures and generate a set of actionable recommendations for improving the AI pipeline. These recommendations may be prioritized based on their potential impact, enabling users to focus their improvement efforts where they will be most effective.

By translating complex metrics into clear explanations and prioritized recommendations, the present disclosure bridges the gap between technical and non-technical understanding. This makes the AI system's performance accessible to a wider audience, empowering product managers, domain experts, and developers alike to understand the root causes of performance issues and participate in the continuous refinement of the AI pipeline.

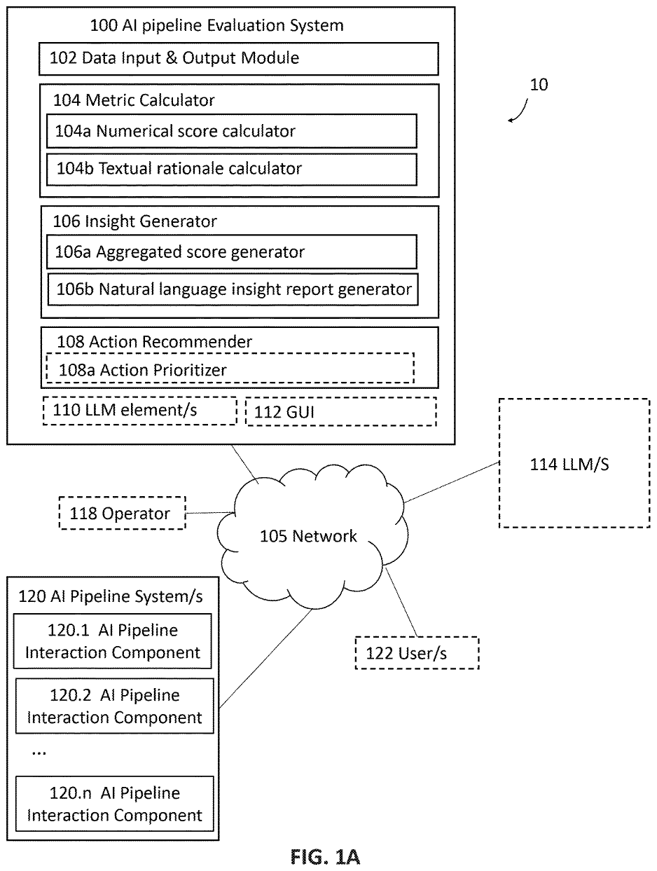

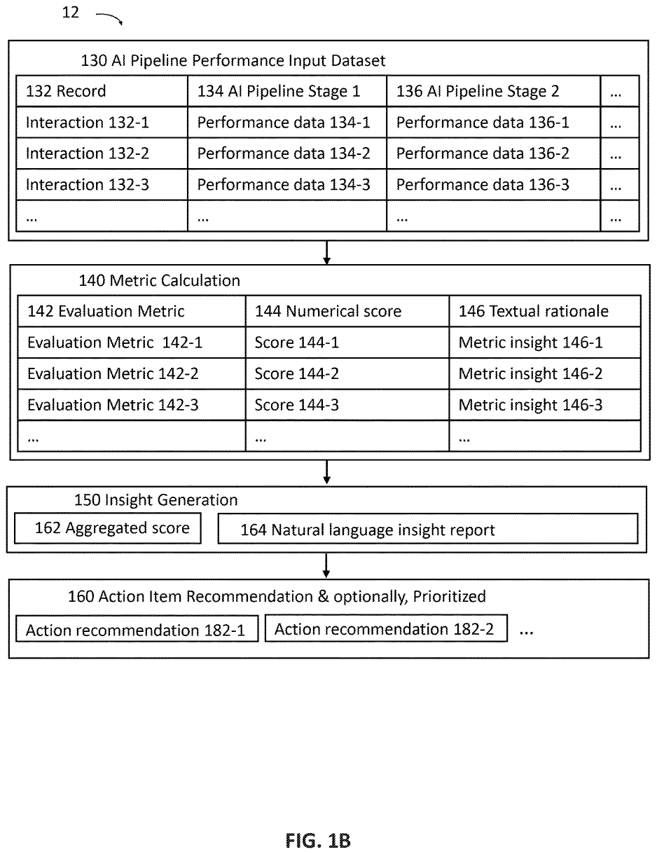

Reference is now made to FIG. 1A, which is a block diagram illustrating an exemplary environment 10 for the explainable evaluation of multi-stage AI pipelines, according to some embodiments of the disclosure. Environment 10 may include an AI pipeline Evaluation System 100, a Network 105, one or more external Large Language Models (LLM/S) 114, optionally an operator device/station/GUI 118, one or more AI pipeline system/s 120, and one or more user device 122.

In some embodiments, AI pipeline system 120 is a multi-stage AI pipeline comprising a plurality of interconnected AI pipeline interaction components 120.1-120.n. The pipeline interaction components may be associated with active elements (processing modules) and passive elements (data objects) interacting with each other in a sequence, thereby executing multiple logical stages to perform a complex task. As used herein, the term ‘pipeline interaction component’ (or ‘pipeline component’) denotes a component of a logical stage that is subject to measurement and evaluation. For example, in a Retrieval-Augmented Generation (RAG) pipeline, the interaction components include: a user query (a passive data input); a retrieved context (a passive data object produced by and indicative of the performance of a retrieval module); a generated answer (a passive data object produced by and indicative of the performance of a generation module); and a ground truth answer (a passive reference data object used for benchmarking).

In certain embodiments, AI pipeline evaluation system 100 may evaluate the performance of AI pipeline system/s 120. Evaluation system 100 may comprise a data input & output module 102, a metric calculator 104, an insight generator 106, an action recommender 108, optionally one or more internal LLM element/s 110, and a Graphical User Interface (GUI) 112. Metric calculator 104 may have a numerical score calculator 104a that may generate quantitative scores, and a textual rationale calculator 104b that may generate corresponding qualitative explanations. Insight generator 106 may have an aggregated score generator 106a and a natural language insight report generator 106b. Action recommender 108 may have an action prioritizer 108a to rank improvement suggestions. Operator 118 may interact with evaluation system 100 via GUI 112. Evaluation system 100 may communicate via network 105 with external resources, such as external LLM/S 114, which may perform calculation, generation, and recommendation tasks. The architecture allows evaluation system 100 to communicatively couple to a datastore (not shown) associated with AI pipeline system/s 120, exist as an integrated element within an AI pipeline (not shown), or serve as a centralized service for evaluating multiple distinct AI pipelines (not shown).

In certain embodiments, the graphical user interface 112 may be configured to manage the presentation of the natural language insight reports generated by insight generator 106. To avoid overwhelming operator 118 or user 122, GUI 112 may not display the full, detailed insight report by default. Instead, GUI 112 may present a user-selectable option, such as a button or hyperlink, which allows the operator 118 or user 122 to reveal the detailed analysis on demand.

FIG. 1B, to which reference is now made, is a data flow diagram 12 illustrating operational stages of AI pipeline evaluation system 100, according to some embodiments of the present disclosure. The process may begin with an AI Pipeline performance input dataset 130. Dataset 130 may contain a plurality of records 132. Each record 132 may correspond to a user interaction with AI pipeline 120 and may include performance data 134-1 from a first AI pipeline stage 1 (134) and performance data 136-1 from a second AI pipeline stage 2 (136), reflecting the multi-stage nature of the pipeline under evaluation.

A metric calculation process 140 may process input dataset 130. For each predefined evaluation metric 142 (e.g., 142-1, 142-2), this process may produce a corresponding numerical score 144 (e.g., score 144-1) and a textual rationale 146 (e.g., metric insight 146-1). This pair of a quantitative score and a qualitative explanation may form a rich evaluation output.

An insight generation process 150 may receive the outputs from metric calculation process 140. This process may synthesize the data from across the dataset to produce at least one aggregated score 162 and a corresponding natural language insight report 164. The aggregated score 162 may be calculated as a mean score, a standard deviation, and an identification of one or more outlier records. Report 164 may provide a high-level diagnosis of performance for each metric.

An action item recommendation process 160 may then receive the insights. This process may perform a holistic analysis of the insight reports to generate a set of structured and optionally prioritized recommendations, such as action recommendation 182-1 and action recommendation 182-2. These recommendations may provide concrete, actionable steps for improving the performance of the AI pipeline.

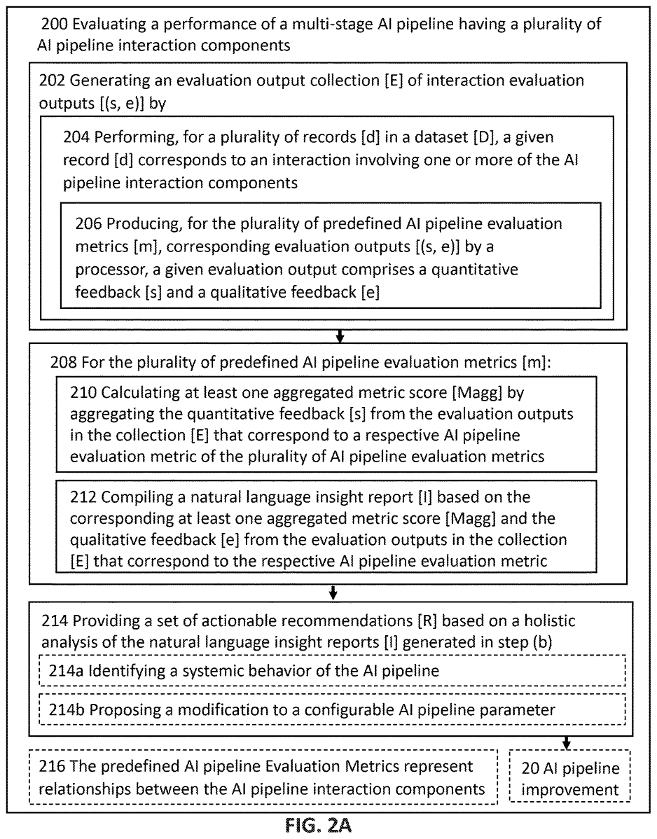

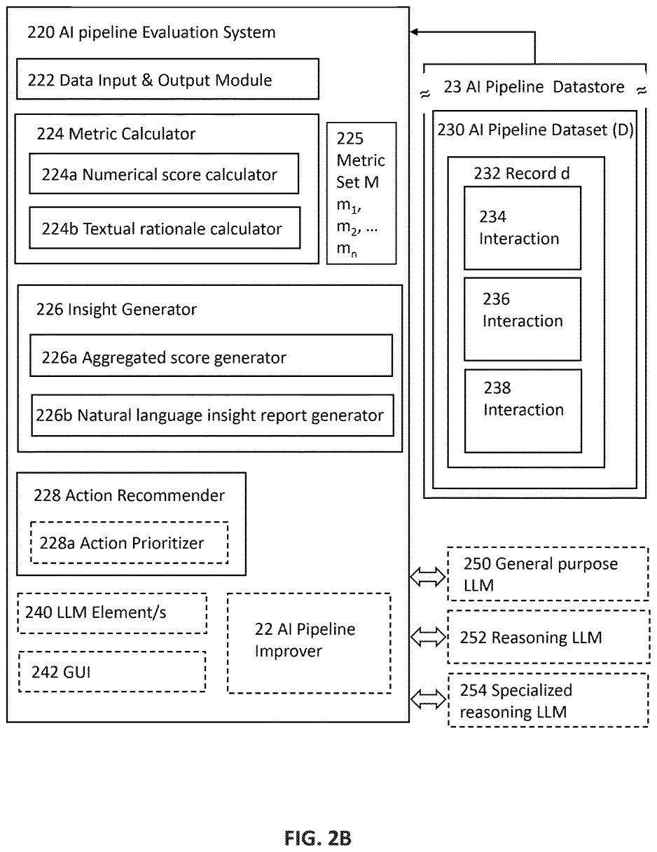

Reference is now made to FIG. 2A, which is a flowchart illustrating a method 200 for evaluating a performance of a multi-stage AI pipeline that has a plurality of AI pipeline interaction components, according to some embodiments of the present disclosure. Method 200 may begin at operation 202, which may generate an evaluation output collection [E] of interaction evaluation outputs [(s, e)]. This step may involve performing (operation 204), for a plurality of records [d] in a dataset [D], an interaction that involves one or more of the AI pipeline interaction components. A processor may produce (operation 206), for a plurality of predefined AI pipeline evaluation metrics [m], corresponding evaluation outputs [(s, e)]. In some embodiments, a given evaluation output of the corresponding evaluation outputs comprises a quantitative feedback [s] and a qualitative feedback [e].

Method 200 may continue at operation 208 by performing operations for the plurality of predefined AI pipeline evaluation metrics [m]. These operations may include calculating (operation 210) at least one aggregated metric score [Magg] by aggregating the quantitative feedback [s] from the evaluation outputs in collection [E] that correspond to a respective AI pipeline evaluation metric. The aggregated metric score [Magg] may be calculated as a mean score, a standard deviation, and an identification of one or more outlier records. The operations may further include compiling (operation 212) a natural language insight report [I] based on the corresponding at least one aggregated metric score [Magg] and the qualitative feedback [e] from the evaluation outputs in collection [E]. In some embodiments, the generation of the corresponding evaluation output for the plurality of records is performed in in parallel.

Subsequently, method 200 may provide (operation 214) a set of actionable recommendations [R]. These recommendations may be based on a holistic analysis of the natural language insight reports [I]. The holistic analysis may comprise identifying a systemic behavior of the AI pipeline (operation 214a) and, as shown in operation 214b, proposing a modification to a configurable AI pipeline parameter. The aspects of proposing and programmatically implementing such modifications, corresponding to the AI pipeline improvement process 20, are detailed further below. In certain embodiments, as shown in operation 216, the predefined AI pipeline evaluation metrics may represent relationships between the AI pipeline interaction components.

FIG. 2B, to which reference is now made, illustrates a block diagram of an AI pipeline evaluation system 220, according to some embodiments of the present disclosure. Evaluation system 220 may include a data input & output module 222, a metric calculator 224, an insight generator 226, an action recommender 228, one or more LLM elements 240, and a GUI 242. In some embodiments, evaluation system may be in communication with one or more large language models, such as a general purpose LLM 250, reasoning LLM 252, or a specialized reasoning LLM 254. Metric calculator 224 may have a numerical score calculator 224a and a textual rationale calculator 224b. Insight generator 226 may have an aggregated score generator 226a and a natural language insight report generator 226b. Action recommender 228 may have an action prioritizer 228a. Evaluation system 220 may operate on an AI pipeline datastore 23 that may contain an AI pipeline dataset [D] 230. Dataset 230 may include a plurality of records [d] 232, where each record corresponds to one or more interactions, such as interaction 234, interaction 236, and interaction 238. Evaluation system 220 may use a predefined metric set M (225), comprising a plurality of metrics m1, m2, ..., mn, to evaluate the performance data within dataset 230. In some embodiments, AI pipeline evaluation system 220 further comprises an AI pipeline improver 22, the structure and operation of which will be detailed further below.

A prominent example of the multi-stage AI pipelines discussed hereinabove is a Retrieval-Augmented Generation (RAG) pipeline, interacting with a user via a user device (element 122 shown in FIG. 1A). RAG pipelines may combine the strengths of large language models with external knowledge retrieval. RAG pipelines aim to produce more factual, relevant, and contextually grounded outputs by integrating retrieved information into a generation process. A RAG pipeline may comprise three or four interaction components-a user input (e.g., a user query/question), context and the generated answer, and optionally a ground truth answer. A RAG pipeline may operate in at least two stages: a retrieval stage that finds relevant context from a knowledge base, and a generation stage that synthesizes an answer based on that context. The quality of the final generated output may depend on the successful operation of both distinct stages.

Evaluating RAG systems may present unique challenges due to the complexity of their pipeline. The quality of the final output may depend on multiple factors, including the relevance of the retrieved information, the faithfulness of the generated text to the retrieved context, and the overall coherence and informativeness of the response. The interplay between the retrieval and generation stages may lead to compounding errors or unexpected behaviors that are difficult to diagnose with conventional metrics.

Furthermore, traditional evaluation metrics for RAG systems and other natural language generation tasks often provide an incomplete assessment of system performance. Traditional evaluation approaches may focus on surface-level similarities or rely on pre-defined reference answers, often providing abstract numerical scores without detailed explanations or actionable insights. This lack of interpretability may make it challenging for developers and researchers to identify specific areas for improvement or understand the root causes of performance issues. For example, a low “factuality” score, which may examine the factual correctness of a generated answer by comparing it to a ground truth reference, may not, by itself, indicate whether the system failed to retrieve the correct facts in the retrieval stage or retrieved the correct facts but failed to adhere to them in the generation stage.

In its application for e.g., RAG pipelines, a system according to embodiments of the present disclosure provides an explanation in a language that even non-experts may understand, enabling them to know how to improve their RAG pipeline. The present disclosure combines numerical metric calculation with natural language explanations and actionable recommendations in a cohesive manner.

Further, explainability in RAG pipelines may be enhanced by a system that leverages specialized language models not just for the RAG task itself, but for the evaluation, insight generation, and recommendation formulation. Such a system may provide a multi-level analysis by examining individual records, dataset-level trends, and systemic issues in the RAG pipeline. By applying explainable AI principles to the multi-stage RAG process, the present disclosure may empower a wider range of users, including product managers and domain experts, to participate in the system improvement process.

The present disclosure describes a system that may categorize identified problems into different priority levels to enable focused improvement efforts, thereby bridging the gap between technical and non-technical understanding. This makes RAG system performance accessible to a wider audience and supports a framework for iterative improvement through repeated evaluation and targeted enhancements.

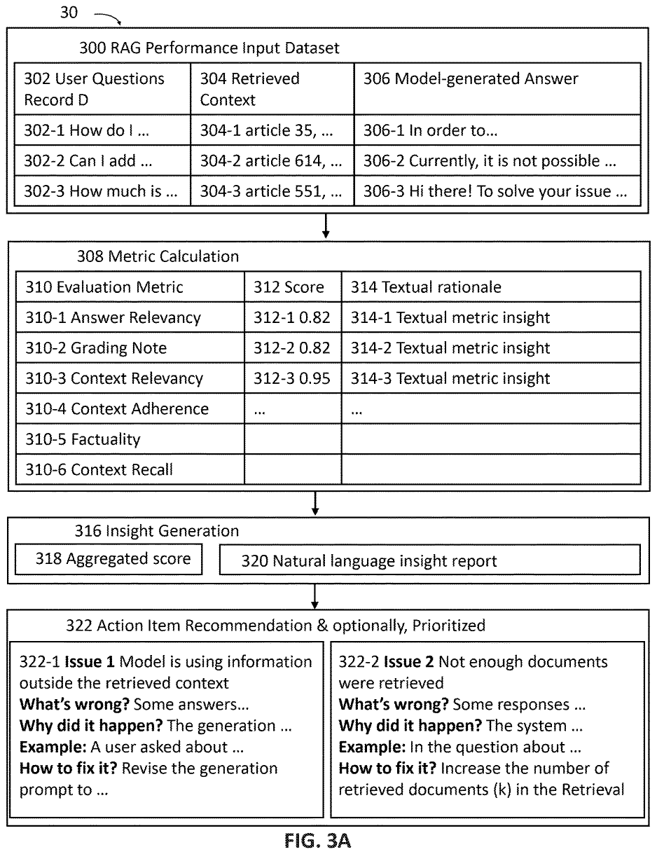

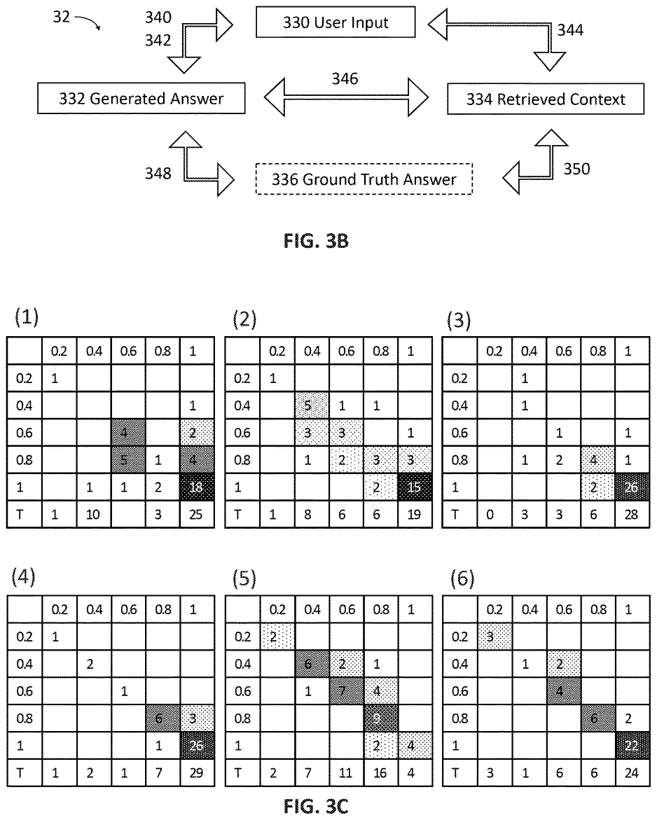

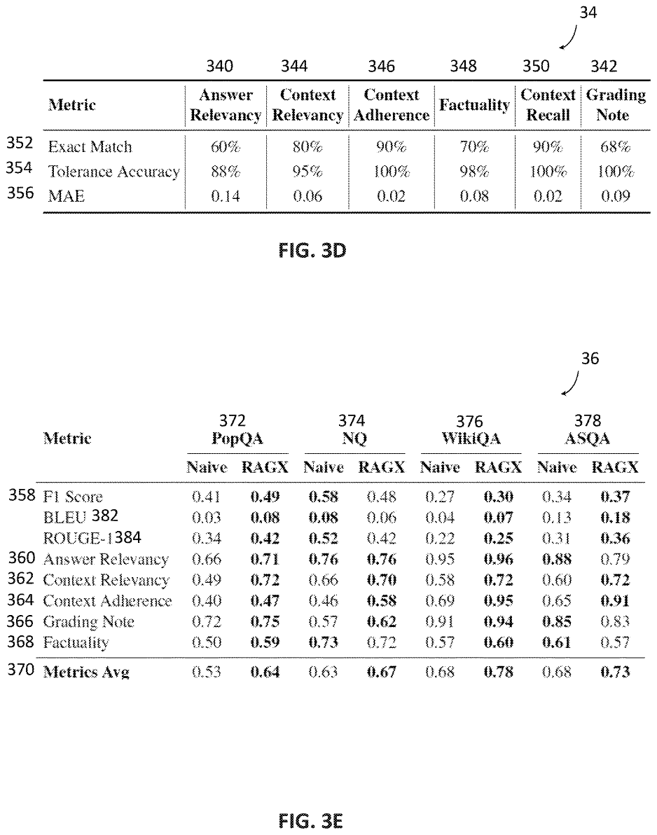

Reference is now made to FIG. 3A, which is a data flow diagram illustrating an exemplary process 30 for evaluating a RAG pipeline, according to some embodiments of the present disclosure. In this illustrative example, process 30 may begin with a RAG performance input dataset 300. This dataset may contain records [d], where each record comprises user questions 302 (also referred to as user input and user query), a retrieved context 304, a model-generated answer 306, and optionally ground truth answer (not shown). For example, a first record may include the user question 302-1 “How do I ...”, the retrieved context 304-1 “article 35, ...”, and the model-generated answer 306-1 “In order to...”. A second record may include the user question 302-2 “Can I add ...”, the retrieved context 304-2 “article 614, ...”, and the model-generated answer 306-2 “Currently, it is not possible ...”.

A metric calculation process 308 may process the input dataset 300. For each evaluation metric 310, this process may generate a score 312 and a textual rationale 314. For instance, for the evaluation metric 310-1 “Answer Relevancy”, assessing how adequately the generated answer addresses the original user's question, the process may generate a score 312-1 of “0.82” and a corresponding textual metric insight 314-1. For the evaluation metric 310-2 “Grading Note”, checking whether the generated answer adheres to an expected structural format and style, the process may generate a score 312-2 of “0.82” and a textual metric insight 314-2. Similarly, for the evaluation metric 310-3 “Context Relevancy”, reflecting how closely the retrieved context aligns with the user's question, the process may generate a score 312-3 of “0.95” and a textual metric insight 314-3. The process may also evaluate other metrics such as context adherence 310-4 (evaluating the degree to which the generated answer is grounded in and faithfully uses only the retrieved context), factuality 310-5, and context recall 310-6 (determining if the retrieved context contains all the necessary information required to generate a correct, ground truth answer).

An insight generation process 316 may then synthesize the data from the metric calculation. This process may produce an aggregated score 318 and a natural language insight report 320. For example, for the “Answer Relevancy” metric, the natural language insight report 320 may state: “Overall, the 0.82 average score indicates moderate alignment between the users' questions and the system's answers. To improve, the generation step should more explicitly restate the user's main need and focus on delivering direct, clear instructions in the answer. A practical refinement could be adding a prompt reminder such as ‘Ensure the answer precisely addresses all parts of the user's question’”.

Subsequently, an action item recommendation process 322 may analyze the insight reports to provide a set of structured and prioritized recommendations. These recommendations are designed to empower users, operators, or automated systems to take specific modification and corrective actions to improve AI pipeline performance. In certain embodiments, each recommendation may comprise a plurality of predefined sections, including: a title for the recommendation; an explanation of the identified systemic behavior, which may include a description of the problem (“What's wrong?”) and a hypothesis for its cause (“Why did this happen?”); an illustrative example selected from the dataset (“Example”); and one or more steps for remediation (“How to fix it?”).

For example, a recommendation for issue 322-1 may have the title “Model is using information outside the retrieved context”. The explanation section—“What's wrong? Some answers. . .”—may describe that some answers contain information not present in the provided context. The hypothesis—“Why did it happen?”—may be that the generation prompt is not sufficiently restrictive. The illustrative example may show a specific user question where the model provided an answer using external knowledge. The steps for remediation—“How to fix it?”—may suggest revising the generation prompt to enforce strict adherence to the retrieved context.

As another example, a recommendation for issue 322-2 may have the title “Not enough documents were retrieved”. The explanation section—“What's wrong?“—may describe that some responses are missing critical information. The hypothesis—“Why did it happen?”—may be that the system's retrieval process is not configured to capture a sufficient number of relevant documents. The illustrative example may show a query where this configuration led to an incomplete answer. The steps for remediation—“How to fix it?”—may suggest modifying a configuration parameter of the retrieval process, such as increasing the number of documents to be retrieved (‘k’).

FIG. 3B, to which reference is now made, illustrates a conceptual diagram of a “metric diamond” 32 for evaluating a RAG pipeline, according to some embodiments of the present disclosure. The metric diamond 32 may provide a visual illustration for the core interaction components in a RAG process and the relationships between them. The vertices of metric diamond 32 may represent the RAG interaction components-a user input 330, a generated answer 332, a retrieved context 334, and an optional ground truth answer 336. Each edge of the diamond may represent a specific relationship between two interaction components, and the evaluation system may assess each relationship with a dedicated metric to provide a holistic, full-chain perspective on pipeline performance. This approach may allow for the precise diagnosis of failure modes, distinguishing, for example, between an issue in the retrieval stage versus the generation stage.

In certain embodiments, the relationship between user input 330 and generated answer 332 may be evaluated by an answer relevancy metric 340 and a grading note metric 342. The answer relevancy metric 340 may check if the generated answer adequately addresses the intent of the original question, ensuring directness and completeness. The grading note metric 342 may check whether the generated answer adheres to an expected structural format and style. This may involve a two-step process where a first LLM call produces a blueprint of an ideal answer structure based on the user's query, and a second LLM call evaluates how closely the actual answer adheres to that blueprint.

The relationship between user input 330 and retrieved context 334 may be evaluated by a context relevancy metric 344. This metric may capture how closely the retrieved context aligns with the user's question, assessing whether the retrieved information is on-topic and pertinent. The relationship between retrieved context 334 and generated answer 332 may be evaluated by a context adherence metric 346. This metric may evaluate whether the model's final answer faithfully uses the retrieved data, as opposed to hallucinating or relying on internal memorized knowledge.

In embodiments where an optional ground truth answer 336 is available, additional relationships may be evaluated. The relationship between ground truth answer 336 and generated answer 332 may be evaluated by a factuality metric 348, which may examine the factual correctness of the generated answer by comparing it to the ground truth reference. The relationship between ground truth answer 336 and retrieved context 334 may be evaluated by a context recall metric 350. This metric may be crucial for diagnosing retriever-stage failures, as it determines if the information necessary to form a correct answer is fully present in the retrieved context.

To assess the quality of the evaluation and the impact of the actionable recommendations generated by the present disclosure, an experiment was performed and will be described with reference to FIGS. 3C-3E.

In the experiments, a baseline “Naive RAG” system was used, based on a FlashRAG implementation, representing a standard RAG pipeline without additional optimizations. The essential FlashRAG parameters of the tested RAG that influence retrieval and generation performance in the experiment are provided herein: Dataset: wiki18 fulldoc; framework: openai; generator model: openai; generator batch size: 25; generator max input len: 50,000; retrieval method: bm 25; retrieval topk: 5; retrieval query max length: 10,000; retrieval batch size: 1024; test sample num: 200; random sample: True; seed: 2024; max tokens: 1024; and temperature: 0.

The prompt used was taken from the open-source FlashRAG implementation: “You are a friendly AI Assistant. Instructions: Respond to the input as a friendly AI assistant, generating human-like text, and follow the instructions in the input if applicable. The following are provided references. You can use them for answering the question. Question: {question} References: {reference}”.

The tested, baseline system was run on various widely used question-answering datasets, such as PopQA, NaturalQuestions (NQ), WikiPassageQA (WikiQA), and ASQA, covering both short-answer and long-form settings. 200 examples per benchmark were sampled across all datasets to capture a representative performance profile. Each example was processed by FlashRAG to generate an answer, after which the tested evaluation metrics were computed.

The experimental evaluation procedure followed the evaluation process of FIG. 3A: In the initial phase of the experiment (following operations 308, 316 and 322 of FIG. 3A), the baseline FlashRAG outputs were assessed. The assessment pertains to a first group of traditional RAG evaluation scores (e.g., F1 Score, BLEU, ROUGE-1) and a second group of metrics, following metric diamond 32 of FIG. 3B. For each record, the tested RAG evaluation system computes a numeric score alongside a brief textual explanation, highlighting any deficiencies detected within the retrieval or generation stages. These per-sample evaluations were aggregated into dataset-level statistics and insight generation, yielding an overall picture of system performance and identifying common areas of concern.

The full prompt guiding the LLM used with tested RAG pipeline evaluation system for insight generation from metric evaluations is provided herein:

Background RAG (Retrieval-Augmented Generation) is a model that combines retrieval and generation capabilities to improve the quality of the answers it provides. The system retrieves information from external data sources and then incorporates it into the generated response. As a result, the model's performance depends on both the quality of retrieval, which involves the retrieved context only, and the quality of generation, which involves the AI response. Evaluation Process: The evaluation consists of assessing both retrieval and generation components separately. Retrieval quality is measured based on how relevant and precise the retrieved context is, while generation quality is assessed based on coherence, correctness, and usefulness of the AI response. Since retrieval does not involve prompting, improvements in this area require adjustments in the retrieval mechanism itself rather than modifying prompt instructions. Instruction: You are an analytical model tasked with providing insights for a given RAG metric evaluation. Follow these steps carefully to analyze the data and draw meaningful observations for the model's builders to improve their model: Parse the contents of Insights which includes: “metric name”: The name of the metric being evaluated. “metric description”: A short description of the metric being measured. “avg score”: The average numeric score for this metric. “random examples”: A list of evaluation samples, where each object provides: “score”: The numeric score for that sample. “explanation”: The reasoning behind the score. “question”: The user's question. “candidate answer”: The model's generated answer being evaluated. “gt answer” (optional): The ground truth/reference answer, if applicable. The ground truth answer is given only for evaluation needs, and the RAG system does not expose to it at all. Evaluate and provide insights based on the following steps: Comment generally on the overall performance of the metric based on “avg score” (e.g., is the performance strong, moderate, or poor?). If the overall performance of the metric is relatively low: Suggest practical improvements that can be implemented to boost the performance of this metric in the future. When possible, provide an exact idea, for example—in the generation parts of the RAG—what exact sentence to include in the prompt, in order to get the desired output. Pay attention—Don't suggest improvement in the prompt if the issue is in the retrieval component. Updating the prompt will not work for the retrieval parts in the RAG process. If the overall performance of the metric is relatively high (at least 0.95): Explain that the overall performance of the metric is great, and that changing it won't lead to a major uplift in the performance. Final Output Provide a concise analysis (3-5 sentences) as plain text. Avoid unnecessary formatting and keep your language clear and direct. Make an insight that ensures that the model's creator knows how to process the input data, provide meaningful qualitative feedback, and offer concise actionable insights for improvement. Note Based on the description, understand which components are relevant to each metric and use only those in your recommendations. We do not provide examples of context as it is too long.

The full prompt guiding the LLM used with tested RAG pipeline evaluation system for in generating actionable recommendations based on the generated insights is provided herein:

Background Context Retrieval-Augmented Generation (RAG) is a hybrid approach combining retrieval-based and generative models to enhance text generation with external knowledge. It consists of two main components: retrieval and generation. In the retrieval stage, a retriever (typically a dense vector model or a sparse method like BM25) searches a knowledge base (e.g., documents, embeddings) using a query derived from the input. The retrieved documents or passages are then passed to the generative model (often a transformer-based LLM with a specific prompt) as additional context. The generation stage uses this context to produce a more informed and relevant response, typically via attention mechanisms that incorporate both the input query and the retrieved content. This architecture allows RAG to generate accurate, up-to-date, and knowledge-rich responses beyond what the model was pre-trained on. Note The Ground Truth (GT Answer), is the “Correct” answer generated by an expert, and was created to evaluate the model, and is NOT part of the answer or the context. Your Task You are tasked with analyzing evaluation results from a Retrieval-Augmented Generation (RAG) pipeline. The analysis should be based on a comprehensive metrics dictionary containing detailed performance insights. Input Format. The input format is a JSON object structured as follows: Listing 1: Example input structure for action item generation (within prompt description): insights={“metric_name_1”: {“metric_description”: “<description>”, “metric_insights”: “<insight>”, “avg_score”: <average_score>, // ... other fields as in your example ... “max_score_example_question_ground_truth_answer”:“<ground_truth_answer_for_max_sco re_example>”}, // ... more metrics or examples ... “example_34”: {“question”: “<question>”, // ... other fields as in your example ... “metric_name_2—Explanation”: “<explanation>”}// ... } (Please see the action generation prompt for a fully rendered example of the input JSON.) Guidelines 1. In your recommendations, elaborate shortly on the hints (one or more) that lead you to provide the recommendation.2. Use the provided insights, scores, and data examples to formulate up to four recommendations that will maximize the % uplift and deliver the most beneficial suggestions (for example: improvement from 97% to 99% is not meaningful).3. Support each recommendation with specific examples from the metrics. Note: The examples provided are randomly sampled with the user's data.4. Maintain a clear connection between metrics insights and proposed improvements. 5. Focus on actionable improvements that directly address identified issues. 6. When mentioning examples, don't use the example number and instead use the example's user question and any other relevant fields. 7. When possible, provide an exact idea, for example-what exact sentence to include in the prompt, in order to get the desired output. 8. Write simple, short and concise explanations and suggestions. 9. Prioritize the suggestions according to their potential to increase the model's score per metric—(High Impact & Priority/Medium Impact & Priority/Low Impact & Priority), and to their implementation feasibility. Rely on the extent of the issue, and explain to the user how much he can improve the score of the specific metric, by implying the suggestion. 10. Don't refer to specific scores in your recommendations. 11. Provide the output in a markdown format. Don't write anything except the markdown code. Output Structure Example. The following illustrates the desired Markdown output structure: Title recommendation (High Impact & Priority) **What's wrong?: **Short explanation **Why did this happen?: **Short explanation **Example: **Clear and concise example with a short explanation **How to fix it?: ** Clear and concise explanation, with specific prompt examples if necessary Title recommendation (Medium Impact & Priority) **What's wrong?: **Short explanation **Why did this happen?: **Short explanation **Example: **Clear and concise example with a short explanation **How to fix it?: **Clear and concise explanation, with specific prompt examples if necessary.

The per-sample evaluations generated by the RAG pipeline evaluation system were compared to human evaluations. The tested set incorporated 40 records, 2 human labelers (annotators), 6 metrics for a total of 240 evaluations. The annotators rated the records and provided reasoning. The comparison results are depicted in FIGS. 3C-3D.

FIG. 3C is a heat map showing a plurality of confusion matrices (1)-(6) depicting the resulting inter-labeler correlations for each of the six evaluation metrics: (1) Answer Relevancy, (2) Grading Note, (3) Context Relevancy, (4) Context Adherence, (5) Factuality, and (6) Context Recall, respectively. In the heat map-style confusion matrices of FIG. 3C, the different shading patterns visually represent the concentration of correlation scores, with darker or denser patterns indicating a higher frequency of data points for a specific score pairing. The strong concentration of values along the main diagonal of each matrix (1)-(6) indicates an excellent alignment between the LLM-based scores of the tested RAG pipeline evaluation system and human preferences. This high alignment between system and human labeling validates the automated metrics as a reliable proxy for human judgment.

FIG. 3D, to which reference is now made, is a table 34 showing a quantitative summary of the alignment between LLM-based metric scores generated by the tested RAG pipeline evaluation system and human preferences. Table 34 shows metrics such as exact match 352, tolerance accuracy 354, and Mean Absolute Error (MAE) 356 for each of the evaluated relationships: answer relevancy 340, grading note 342, context relevancy 344, context adherence 346, factuality 348, and context recall 350. The low MAE values, such as 0.02 for context recall 350, quantitatively demonstrate the strong correlation observed in FIG. 3C.

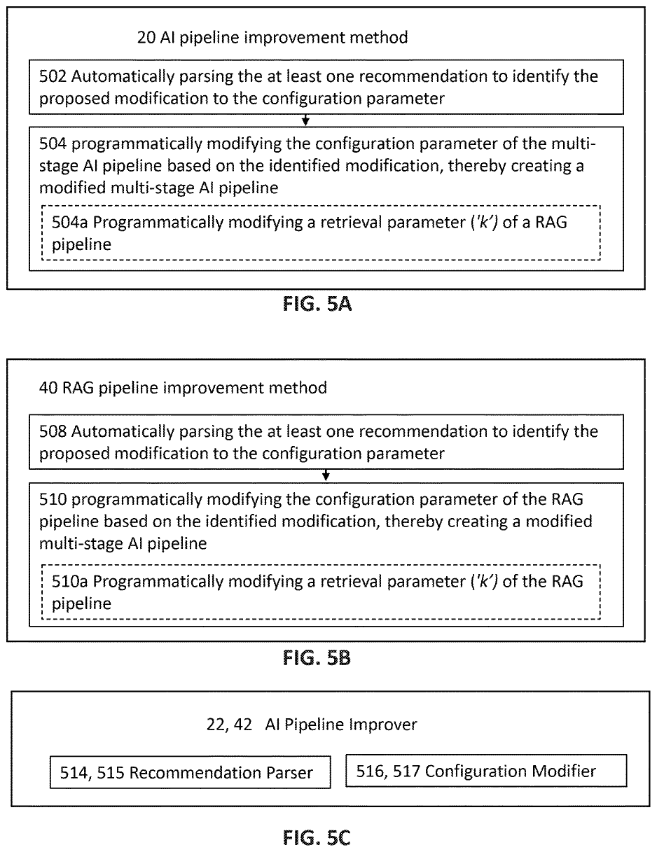

In a second phase of the experiment, to assess the impact of the results provided by the tested RAG evaluation system, specific, predefined modifications were systematically implemented to the baseline “Naive RAG” system (following operation 20 AI pipeline improvement which will be discussed further below with reference to FIGS. 5A and 5B).

The RAG pipeline modifications were directly guided by the general categories of issues and solution types (e.g., insufficient document retrieval, poor context adherence) that traditional RAG evaluation systems typically address. The specific programmatic interventions, represent concrete instantiations of these broader recommendation themes, chosen to ensure experimental consistency and reproducibility.

The natural language insights generated by the tested RAG evaluation system were programmatically mapped to specific modifications in the FlashRAG configuration of the experiment (“Naive”).

The tested RAG evaluation system identified recurring issues and provided corresponding insights. Targeted programmatic adjustment was automatically applied. This automated application of improvements was chosen to ensure experimental consistency and reproducibility, allowing for a clear measure of the recommendations'direct effect.

Additional key improvements implemented were:
(i) Insight: “Not Enough Documents Retrieved”. Action: The retrieval topk parameter (representing k, the number of documents retrieved) was doubled.
(ii) Insight: “Incomplete Generated Answer Due to Low max completion tokens”. Action: The generation params[“max tokens”]value was multiplied by 10.
(iii) Insight: “Conflicting or Noisy Information in Retrieval”. Action: The following text was prepended to the generation prompt, immediately before the Question: [question] place-holder: “Carefully assess each provided reference and use only the relevant ones for generating the response.”
(iv) Insight: “Model is Using Information Outside the Retrieved Context” Action: The following text was prepended to the generation prompt, immediately before the Question: [question] place-holder: “Base your response strictly on the provided reference. Do not incorporate external knowledge. Only include facts directly referenced in the retrieved documents.”

The revised tested FlashRAG pipeline (denoted in the experiment results as “RAGX”) was re-run on the same 200-sample benchmark, and the resulting outputs were re-evaluated to quantify improvements across all metrics.

FIG. 3E summarizes the performance of the FlashRAG pipeline before (“Naive”) and after (“RAGX”) incorporating the improvements suggested by the tested RAG evaluation system. Table 36 shows mixed metric changes, with improvements in several metrics and datasets, decreases in others, and an increase in the average metric score (370) across all tested datasets (372, 374, 376, 378). For example, on the WikiQA dataset (376), the average of metrics (370) shows a clear uplift from 0.68 to 0.78.

The table further reveals a nuanced performance profile, highlighting a strategic trade-off between traditional metrics (358, 382, 384) and explainability metrics (360, 362, 364, 366, and 368). For instance, on the ASQA dataset (378), the context adherence score (364) improved significantly from 0.65 to 0.91, and on the WikiQA dataset (376), it improved from 0.69 to 0.95, demonstrating that the enhancements effectively promote more faithful and contextually grounded responses. This deliberate shift towards higher faithfulness results in lower scores for some traditional metrics on certain datasets. For example, on the NQ dataset (374), the F1 Score (358) decreased from 0.58 to 0.48. This effect occurs because the enhanced system correctly refrains from generating answers when the retrieved evidence is insufficient, rather than relying on its internal, un-grounded knowledge, which may inflate scores on certain benchmarks.

This strategic trade-off—sacrificing high scores on some traditional metrics for provably higher faithfulness may be desirable in many high-stakes domains where the cost of incorrect information is significant. In fields such as medicine or law, the primary requirement for an AI system is to provide a trustworthy and verifiable one. The present disclosure addresses this challenge. The significant improvements shown in the Context Adherence metric (364) in FIG. 3E—for example, the increase from 0.69 to 0.95 on the WikiQA dataset (376)—demonstrate that the enhanced system has been successfully trained to ground its generated answers (332) strictly in the provided retrieved context (334).

Consequently, when the retrieved context is insufficient or lacks the specific information needed to answer a user's question, the enhanced system correctly opts not to generate a factually unsupported response. Instead, it indicated that the information is unavailable. This behavior resulted in some traditional metrics, such as the F1 Score (358) on the NQ dataset (374), showing a decrease from 0.58 to 0.48. A conventional system might have generated an answer from its internal memorized knowledge, which could have coincidentally overlapped with the ground truth answer, thereby achieving a higher F1 score. The system of the present disclosure, however, correctly prioritizes faithfulness over speculation.

Furthermore, the consistent gains in Context Relevancy (362) across all datasets confirm that the systematic modifications based on the evaluation system's insights successfully reduce retrieval errors. This indicates a clear improvement in the retrieval stage of the RAG pipeline.

Taken together, the results shown in FIG. 3E not only quantify the net positive performance gains but also validate that the actionable recommendations generated by the system are closely aligned with the underlying AI pipeline deficiencies. The analysis demonstrates the value of the integrated explanation module in diagnosing specific failure modes—such as retrieval versus generation errors—and guiding targeted, effective improvements to the AI pipeline.

The experimental findings suggest that embodiments of the present disclosure may significantly lower the barrier to understanding why a RAG pipeline underperforms. By explicitly linking poor scores to pipeline interaction components and stages and enumerating potential fixes, the RAG evaluation system of the present disclosure aligns with the call for “actionable metrics”. The user-centric design of embodiments of the present disclosure contrasts with developer-focused frameworks that often require domain expertise to interpret multi-stage metrics. By enhancing process visibility, the RAG evaluation system of the present disclosure may facilitate improved human-AI interaction and enable informed trust based on clear reasoning chains and transparent evaluation criteria.

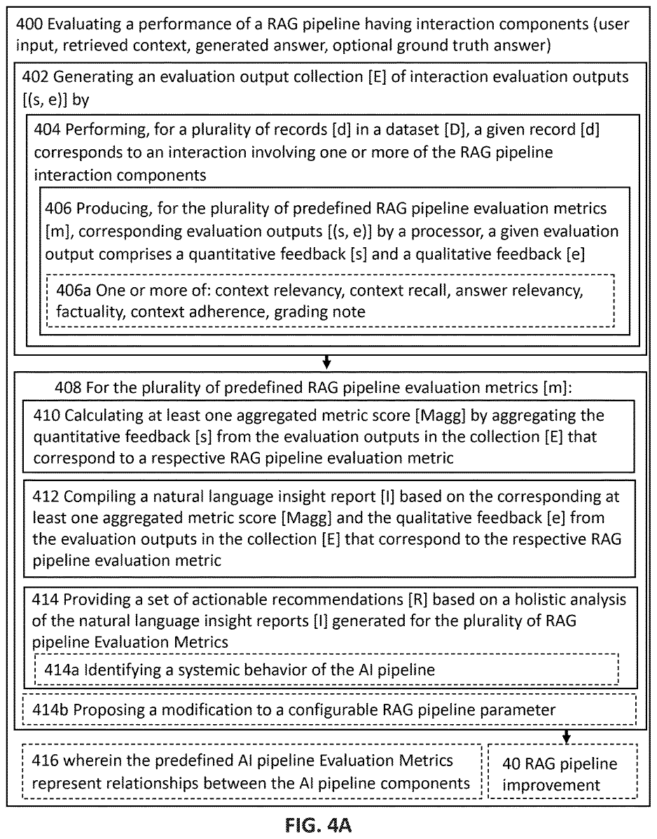

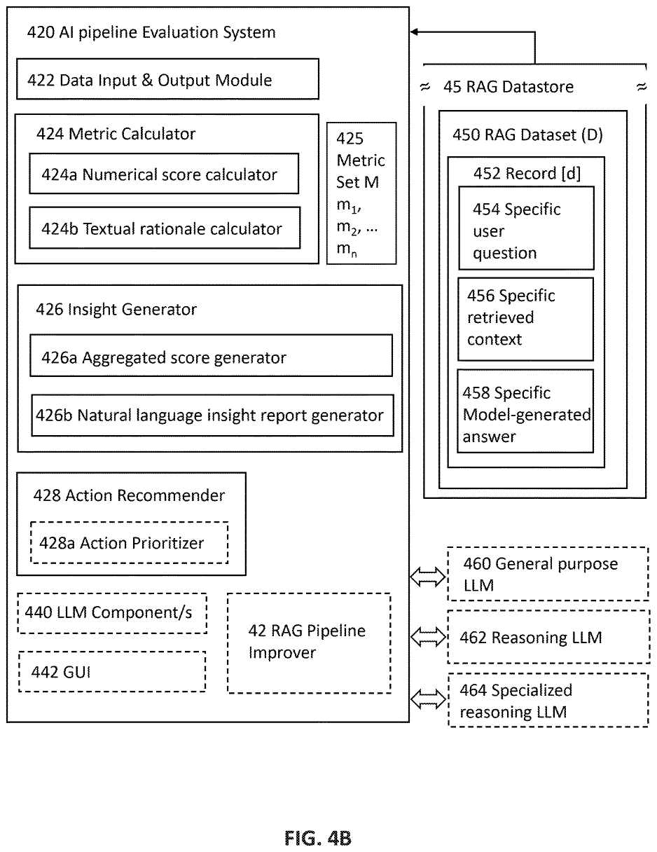

Reference is now made to FIG. 4A, which is a flowchart illustrating a method 400 for evaluating the performance of a RAG pipeline, according to some embodiments of the present disclosure. The RAG pipeline may have a plurality of RAG pipeline interaction components, such as a user input, a retrieved context, a generated answer, and an optional ground truth answer. These interaction components directly correspond to the vertices of the metric diamond 32 shown in FIG. 3B (user input 330, retrieved context 334, generated answer 332, and optional ground truth answer 336).

Method 400 may begin at operation 402, which may generate an evaluation output collection [E] of interaction evaluation outputs [(s, e)]. This operation may involve performing (operation 404), for a plurality of records [d] in a dataset [D], an interaction involving one or more of the RAG pipeline interaction components. A processor may then produce (operation 406), for a plurality of predefined RAG pipeline evaluation metrics [m], corresponding evaluation outputs [(s, e)]. In some embodiments, the generation of the corresponding evaluation output for the plurality of records is performed in in parallel.

In some embodiments, the predefined RAG evaluation metrics [m] may include one or more of: context relevancy, context recall, answer relevancy, factuality, context adherence, and grading note. These specific metrics correspond to the evaluated relationships (edges 340, 342, 344, 346, 348, 350) within the metric diamond 32 shown in FIG. 3B.

Method 400 may continue at operation 408 by performing operations for the plurality of predefined RAG pipeline evaluation metrics [m]. These operations may include calculating (operation 410) at least one aggregated metric score [Magg] and compiling (operation 412) a natural language insight report [I]. Subsequently, method 400 may provide (operation 414) a set of actionable recommendations [R] based on a holistic analysis of the insight reports. This analysis may comprise identifying a systemic behavior of the RAG pipeline (operation 414a) and optionally proposing (operation 414b) a modification to a configurable RAG pipeline parameter. The aspects of proposing and programmatically implementing such modifications, as represented by box 40 RAG pipeline improvement, are detailed further below. In some embodiments, the predefined RAG evaluation metrics are selected such that they reflect the relationships between the RAG pipeline interaction components.

FIG. 4B, to which reference is now made, illustrates a block diagram of an AI pipeline evaluation system 420 configured for evaluating a RAG pipeline, according to some embodiments of the present disclosure. Evaluation system 420 may include a data input & output module 422, a metric calculator 424, an insight generator 426, an action recommender 428, and a GUI 442. RAG pipeline evaluation system may be equipped with one or more LLM elements 440, or be in data communication with one or more large language models, such as general purpose LLM 460, reasoning LLM 462, or a specialized reasoning LLM 464.

In this RAG-specific embodiment, evaluation system 420 may operate on a RAG datastore 45, being part of a RAG pipeline (not shown) or in communication therewith. RAG datastore 45 may contain a RAG dataset [D] 450. A record [d] 452 within the dataset 450 may comprise the specific elements of a RAG interaction, including a specific user question 454, a specific retrieved context 456, and a specific model-generated answer 458. These interaction components directly correspond to the illustrative data shown in RAG performance input dataset 300 of FIG. 3A (user questions 302, retrieved context 304, and model-generated answer 306). Furthermore, specific user question 454, specific retrieved context 456, and specific model-generated answer 458 correspond to the vertices of the metric diamond 32, namely user input 330, retrieved context 334, and generated answer 332, respectively. Evaluation system 420 may use a predefined metric set M (425) to evaluate the performance data within RAG dataset 450.

The assessment of the RAG pipeline evaluation described with reference to FIGS. 3C-3E demonstrated that by uniting quantitative metrics with detailed, actionable feedback derived representing relations between pipeline interaction components, the evaluation not only benchmarks overall performance but also provides clear guidance on targeted improvements for the RAG pipeline.

Further, while the described embodiments of the AI pipeline evaluation system are intended to empower users with insights for manual, nuanced system tuning, the design of the experiment detailed hereinabove isolates and quantifies the efficacy of the automated diagnostic and improvement capabilities of the AI pipeline evaluation system.

A system and method for automated improvement (or modification) of an AI pipeline, such as a RAG pipeline, in accordance with an aspect of the present disclosure, will be now discussed with reference to FIGS. 5A-5C.

Reference is now made to FIG. 5A, which is a flowchart detailing the modification process 20 for a general multi-stage AI pipeline, as introduced in optional operation 214b of FIG. 2A. The process may begin by automatically parsing (operation 502) at least one recommendation to identify a proposed modification to a configuration parameter. Subsequently, the process may programmatically modify (operation 504) the configuration parameter of the multi-stage AI pipeline based on the identified modification, thereby creating a modified multi-stage AI pipeline. In the case the AI pipeline is a RAG pipeline, operation 504 may comprise operation 504a of programmatically modifying a retrieval parameter (‘k’) of a RAG pipeline.

FIG. 5B, to which reference is now made, is a flowchart detailing the analogous modification process 40 for a RAG pipeline, as introduced in operation 414b of FIG. 4A. The process may automatically parse (operation 508) at least one recommendation to identify a proposed modification. It may then programmatically modify (operation 510) the configuration parameter of the RAG pipeline based on the identified modification. Operation 510a shows the specific example of programmatically modifying a retrieval parameter (‘k’) of the RAG pipeline.

Reference is now made to FIG. 5C, which is a block diagram illustrating the system elements that may execute the modification process. A processor 22, 42 (as shown in FIGS. 2B and 4B) may comprise a recommendation parser 514, 515 and a configuration modifier 516, 517. The recommendation parser 514, 515 may perform the parsing operations 502, 508, and the configuration modifier 516, 517 may perform the programmatic modification operations 504, 510.

The system according to some embodiments, provides for the automated improvement of the AI pipeline by programmatically modifying its configuration parameters based on actionable recommendations. This process is executed by an AI Pipeline Improver element (22, 42), which may comprise a recommendation parser (514, 515) and a configuration modifier (516, 517) as shown in FIG. 5C, and operates according to a defined protocol to ensure changes are both effective and safe.

To facilitate reliable automatic parsing, the action recommender (108, 228, 428) may be configured to generate recommendations in a structured, machine-readable format. While one embodiment may use a structured markdown format as illustrated in the action item recommendation prompt output example, other embodiments may prompt the reasoning LLM to generate its output as a JSON object. The JSON object defines a specific output schema, which may include fields such as: parameter_name: A string identifying the exact configuration parameter to be modified (e.g., “retrieval_topk” or “generation_params. max_tokens”); proposed_value: The new value for the parameter, formatted according to its expected data type (e.g., integer, float, string); modification_type: An instruction indicating how to apply the value (e.g., “replace”, “multiply”, “prepend_string”); and rationale: A human-readable text string explaining the reason for the change, derived from the insight report.

The programmatic modification of the AI pipeline follows a safe configuration-change protocol, executed by the configuration modifier 616. This protocol is designed to prevent invalid or harmful changes and to ensure system stability.

The safe configuration-change protocol may comprise several steps:
(i) Parsing and validation: The recommendation parser 514 first ingests the structured recommendation (e.g., the JSON object). The configuration modifier 616 then validates the proposed modification against a predefined schema of permissible parameters and their constraints. This validation step confirms that: (a) the parameter_name corresponds to a known, modifiable parameter of the AI pipeline; (b) the proposed_value is of the correct data type (e.g., integer for a token count); and (c) the proposed_value falls within a predefined safe range (e.g., ensuring a retrieval parameter ‘k’ is not set to an excessively high value that would degrade performance). Any recommendation failing validation is logged and discarded.
(ii) Configuration versioning: Rather than overwriting the live configuration, the configuration modifier 616 may create a new, versioned configuration file or object. This new version incorporates the validated modification while preserving the previous configuration. This non-destructive approach ensures that the system can be rolled back to a previous known-good state if the new configuration leads to performance degradation.
(iii) Application and logging: The modified multi-stage AI pipeline may be instantiated using the new, versioned configuration. The change, including the parameter, its old and new values, and the associated rationale, is logged in an audit trail. This log provides transparency and traceability for all automated changes made to the system.

This automated and safe protocol allows the system to iteratively self-improve by translating high-level, LLM-generated insights into specific, validated, and reversible configuration changes, thereby closing the loop from performance evaluation to pipeline improvement.

The present disclosure also describes a method and system for validating the performance of the automated evaluation system itself. This validation process may be needed during development and deployment of the AI pipeline evaluation system to ensure the automated evaluation scores are trustworthy and align with human judgment, which may be a requirement for certain AI pipelines operating in high-stakes domains.

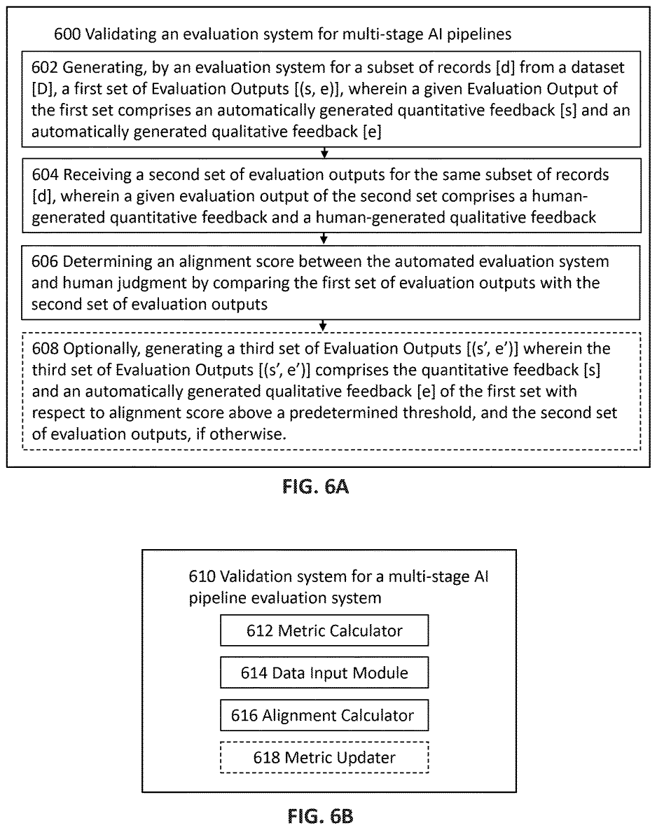

FIG. 6A, to which reference is now made, is a flowchart illustrating a method 600 for validating an automated evaluation system for multi-stage AI pipelines. The method may begin by generating (operation 602), using the automated evaluation system for a subset of records [d] from a dataset [D], a first set of evaluation outputs [(s, e)]. In this first set, a given evaluation output may comprise an automatically generated quantitative feedback [s] and an automatically generated qualitative feedback [e]. The method may then receive (operation 604) a second set of evaluation outputs for the same subset of records [d], wherein a given evaluation output of this second set comprises a human-generated quantitative feedback and a human-generated qualitative feedback. Finally, the method may determine (operation 606) an alignment score between the automated evaluation system and human judgment by comparing the first set of evaluation outputs with the second set of evaluation outputs. This process corresponds to the validation study discussed with reference to FIGS. 3C and 3D.

Optionally, the method may further comprise generating (operation 608) a third set of evaluation outputs [(s', e')]. This third set may comprise the quantitative feedback [s] and the automatically generated qualitative feedbcack [e] of the first set if the alignment score is above a predetermined threshold, and may comprise the second set of human-generated evaluation outputs otherwise.

In certain embodiments, method 600 may be incorporated into method 200 to create a semi-automated, human-validated evaluation process. In such a “human-in-the-loop” scenario, the AI pipeline evaluation system may first generate its automated evaluation outputs (the first set) as part of its standard process. For a subset of these records, the system may trigger a validation check by requesting input from a human operator, who provides the second, human-generated set of evaluation outputs. The system may then calculate an alignment score (operation 606) and, based on a predetermined threshold, generate a third, hybrid set of evaluation outputs (operation 608). This third set may selectively combine the trusted, high-alignment automated outputs with the corrected, human-generated outputs. This more reliable, human-validated collection of evaluation outputs may then be used for the subsequent insight generation (operation 212) and recommendation generation (operation 214) stages of method 200, leading to more robust and trustworthy final recommendations.

FIG. 6B, to which reference is now made, illustrates a block diagram of a validation system 610 for a multi-stage AI pipeline evaluation system. The validation system 610 may comprise a metric calculator 612, a data input module 614, an alignment calculator 616, and an optional metric updater 618. The metric calculator 612 may generate the first set of automated evaluation outputs. The data input module 614 may receive the second set of human-generated evaluation outputs. The alignment calculator 616 may then compare the two sets to determine an alignment score. The metric updater 618 may receive the first and second sets of evaluation outputs and the alignment score, and may generate a third, hybrid set of evaluation outputs based on a predetermined threshold, as described in operation 608 of method 600.

In certain embodiments, validation system 610 may be incorporated with an evaluation system, such as evaluation system 220 of FIG. 2B, to create a semi-automated, human-validated evaluation system. In such a “human-in-the-loop” scenario, metric calculator 224 of evaluation system 220 may generate the first set of automated evaluation outputs. For a subset of records, data input module 614 of validation system 610 may receive the second, human-generated set of outputs, for example via GUI 242 of evaluation system 220. Alignment calculator 616 may then determine the alignment score. Based on this score, metric updater 618 may generate the third, trusted set of evaluation outputs. This human-validated output collection may then be passed to insight generator 226 and action recommender 228 of evaluation system 220 to generate more robust and trustworthy insights and recommendations.

In certain embodiments of the present disclosure, the various processors that execute the evaluation and recommendation tasks may be implemented using one or more large language models (LLMs). As shown in FIG. 1A, these may include internal LLM element/s 110 or external LLM/s 114. Specifically, the metric calculator 104, the insight generator 106, and the action recommender 108 may each be implemented as, or leverage, an LLM configured for their respective tasks.

Different stages of the evaluation process may use different LLMs, which may be selected or optimized for the specific requirements of each task. Such LLMs may comprise specialized reasoning LLM and reasoning LLM.

For example, the metric calculator 104/224/424, which functions as an “LLM-as-judge” to generate the evaluation outputs [(s, e)], may be a powerful model with strong assessment capabilities, such as models from the GPT-4 family or Claude 3 family. The specialized reasoning LLMs used for the insight generator 106/226/426 and the action recommender 108/228/428 may be models optimized for efficiency in synthesis and reasoning tasks. As an illustrative, non-limiting example, these reasoning LLMs may be models such as o3-mini or Deepseek R1. This use of distinct, fit-for-purpose LLMs at different stages may enhance both the accuracy of the evaluation and the efficiency of the overall system.

While many embodiments of the present disclosure are described herein with reference to Retrieval-Augmented Generation (RAG) pipelines and their associated metrics, it will be appreciated that the disclosed methods and systems for explainable evaluation and automated improvement are broadly applicable to a wide variety of multi-stage AI pipelines, each with its own set of domain-specific performance metrics. The core principles of generating paired quantitative scores and qualitative rationales for distinct pipeline stages, synthesizing these into insight reports, and providing actionable recommendations may be applied to any pipeline where performance can be diagnosed and improved by analyzing its constituent interaction components and their respective metrics and relations.

For example, the present disclosure may be applied to an autonomous vehicle pipeline where performance is measured by metrics related to safety and smoothness. Such a pipeline may comprise a first stage for multi-modal sensor data ingestion, a second stage for neural reconstruction of a world model, and a third reasoning stage for determining a responsive action. The evaluation system (e.g., 220) may generate a quantitative score for a metric such as “Jerk & Smoothness” and a qualitative rationale explaining why the jerk was high (e.g., “the reasoning agent issued overly aggressive acceleration commands in response to perceived gaps in traffic”). Similarly, it may evaluate a “Timestamp Desync” metric, and the insight report may suggest that a time lag between LiDAR and camera feeds is causing the AI to hallucinate an object's position, leading to a low “Miles Per Intervention (MPI)” score.

In yet another embodiment, the present disclosure may evaluate a real-time video analytics pipeline where performance is measured by metrics related to temporal consistency and latency. This pipeline may include a perception stage for object detection and tracking and a subsequent behavioral analysis stage. The evaluation system could score the pipeline on a “Multiple Object Tracking Accuracy (MOTA)” metric, and the textual rationale could pinpoint specific scenarios causing low scores, such as “frequent ID switches occurring during periods of heavy occlusion.” Based on this insight, the action recommender could propose modifications to parameters in the tracking algorithm to improve performance and reduce the “False Discovery Rate” of anomaly alerts.

In a further embodiment, the present disclosure may be applied to a medical imaging and diagnostic pipeline where precision is critical. The pipeline may comprise a segmentation stage, a reasoning stage, and a report generation stage. The system may evaluate the “Dice Coefficient (DSC)” metric, which measures the overlap between the AI's segmented tumor and a ground truth from a radiologist. A low score's rationale might indicate “systematic under-segmentation of tumor boundaries in low-contrast MRI scans.” This could trigger a recommendation to retrain the segmentation model on a dataset enriched with such images. Furthermore, the “human-in-the-loop” validation methods described herein may be particularly relevant, ensuring high “Sensitivity” and “Negative Predictive Value (NPV)” by comparing automated scores with human evaluations to ensure trustworthiness.

In still another embodiment, the present disclosure may evaluate complex, agentic reasoning pipelines where performance is measured by efficiency and logical soundness. Such a pipeline may comprise a planner agent, one or more tool agents, and a critic agent. The evaluation system may assess a “Step Efficiency” metric, comparing the agent's path to an optimal one. The insight report could then diagnose that “the planner agent is creating redundant sub-tasks, leading to unnecessary loops and increased token consumption.” The action recommender could then suggest modifications to the planner agent's prompt to improve its “Plan Adherence” and “Tool Selection Accuracy,” thereby enhancing the overall token and cost efficiency of the system.

Although the drawings depict certain elements of the system, for example, internal LLM element/s 110 and external LLM/S 114, additional LLM-related elements that enable their operation are not explicitly illustrated for simplicity. These elements, such as model interface elements, prompt generators, response parsers, and execution engines—whether implemented internally within the AI pipeline evaluation system 100 or externally via remote services—form part of the system's architecture and interact with the depicted elements to enable the claimed functionality, as would be understood by a person of ordinary skill in the art.

Although not explicitly depicted in the drawings for clarity, the evaluation system of embodiments of the present disclosure may incorporate additional LLM-related elements that enable the processing steps carried out by the internal LLM element/s 110 or external LLM/s 114. These LLM elements may be comprised e.g., within the metric calculator 104, the insight generator 106, and the action recommender 108, which leverage LLM capabilities to perform their respective functions.

The additional LLM-related components may include one or more of: (i) A model interface element: A software module configured to communicate with a text generation modeling system implementing a large language model (LLM), such as a transformer-based model (e.g., GPT-series, LLaMA, or PaLM) accessible locally or remotely via one or more application programming interfaces (APIs). The model interface element receives prompts from upstream elements and transmits LLM outputs (e.g., generated text, embeddings, or classifications) downstream for further processing; (ii) A prompt generator element: Configured to structure input data—such as user queries, context from non-LLM elements, or retrieved documents—into optimized prompts for the LLM. For example, the prompt generator may apply template filling, chain-of-thought prompting, or few-shot examples to enhance LLM performance for the specific task; (iv) A response parser element: Processes raw LLM outputs (e.g., free-form text) to extract structured results, such as classifications, numerical scores, key-value pairs, or ranked lists, for integration with the system's non-LLM workflow; and (v) An LLM execution engine: Executes a locally hosted LLM model loaded into system memory, utilizing one or more processors and accelerators (e.g., GPUs, TPUs) for inference. In external embodiments, the execution engine may route requests to a remote LLM service (e.g., a cloud-based API endpoint).

The LLM-related elements described hereinabove may be implemented as dedicated software modules stored in memory and executed by the system's processor(s), or as cloud-based services integrated via network interfaces. Interaction flows may include: (1) upstream elements providing input data to the prompt generator; (2) the model interface transmitting the generated prompt to the LLM execution engine; (3) the response parser processing the raw LLM output; and (4) downstream elements consuming the parsed result. The specific configuration—internal versus external LLM—is selectable based on latency, cost, or privacy requirements, with no change to the overall system functionality. In embodiments where the LLM elements are external, the AI pipeline evaluation system 100 may communicate over a network (105) using standardized protocols (e.g., RESTful APIs, gRPC). Security features, such as API key authentication, rate limiting, and input sanitization, may be incorporated in respective model interfaces to mitigate risks.

Unless specifically stated otherwise, as apparent from the preceding discussions, it is appreciated that, throughout the specification, discussions utilizing terms such as “analyzing,” “generating,” “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

The inventive elements discussed hereinabove may be implemented on a suitable apparatus. This apparatus may be specially constructed for the desired purposes, or it may comprise a computing device or system typically having at least one processor and at least one memory, selectively activated or reconfigured by a computer program, code or prompt. The resultant apparatus when instructed by program, code or prompt may turn the general-purpose computer into inventive elements as discussed herein. The program, code or prompt may define the inventive device in operation with the computer platform for which it is desired. Such program, code or prompt may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing programs, code or prompts. The computer readable storage medium may also be implemented in cloud storage.

Some general-purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present disclosure are not described with reference to any particular programming language. It will be appreciated that a variety of programming languages may be used to implement the teachings of the disclosure as described herein.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed is:

1. A computer-implemented method for evaluating a performance of a multi-stage AI pipeline having a plurality of AI pipeline interaction components, the method comprising:
generating a collection of evaluation outputs, one or more of which comprising a quantitative feedback and a qualitative feedback;
aggregating the quantitative feedback from the evaluation outputs to generate at least one aggregated metric score for the AI pipeline; and
compiling a natural language insight report based on the corresponding at least one aggregated metric score and the qualitative feedback of the evaluation outputs; and
providing a set of actionable recommendations based on a holistic analysis of the natural language insight reports.

2. The method of claim 1, wherein generating a collection of evaluation outputs comprises generating, for a plurality of records in a dataset, wherein a given record corresponds to an interaction involving one or more of the AI pipeline interaction components, a respective set of evaluation outputs based on a plurality of predefined AI pipeline evaluation metrics.

3. The method of claim 1 wherein the holistic analysis comprises identifying a systemic behavior of the AI pipeline.

4. The method of claim 1, further comprising prioritizing the set of actionable recommendations based on an impact on system performance, the impact on system performance comprising at least a high impact level and a medium impact level.

5. The method of claim 1, wherein the multi-stage AI pipeline is a RAG (Retrieval-Augmented Generation) pipeline, and wherein the AI pipeline interaction components comprise: a user input, a retrieved context, and a generated answer.

6. The method of claim 2, wherein the multi-stage AI pipeline is a RAG (Retrieval-Augmented Generation) pipeline, and wherein the plurality of AI pipeline evaluation metrics is selected from the group consisting of: context relevancy, answer relevancy, context adherence, and grading note.

7. The method of claim 2, wherein the multi-stage AI pipeline is a RAG (Retrieval-Augmented Generation) pipeline, and wherein the AI pipeline interaction components further comprise a ground truth answer, and wherein the plurality of AI pipeline evaluation metrics is selected from the group consisting of: context relevancy, context recall, answer relevancy, factuality, context adherence, and grading note.

8. The method of claim 2, wherein the plurality of predefined AI pipeline evaluation metrics is configured to evaluate a relationship between at least two of the AI pipeline interaction components.

9. The method of claim 1, wherein the at least one aggregated metric score is selected from the group consisting of: a mean score, a standard deviation, and an identification of one or more outlier records.

10. The method of claim 3, wherein each of the actionable recommendations comprises a plurality of predefined sections, the sections including: (i) a title for the recommendation; (ii) an explanation of the identified systemic behavior; (iii) an illustrative example selected from the dataset; and (iv) one or more steps for remediation.

11. The method of claim 10, wherein the explanation of the identified systemic behavior comprises a description of what is wrong with the AI pipeline's performance and a hypothesis for why it happened.

12. The method of claim 10, wherein the multi-stage AI pipeline is a RAG (Retrieval-Augmented Generation) pipeline, and wherein the one or more steps for remediation comprise specific, contextual advice formulated based on the holistic analysis, the advice including at least one of: a modification to a retrieval parameter or a modification to a generation prompt.

13. The method of claim 1, wherein the step of generating the collection of evaluation outputs further comprises: performing the generation of the corresponding evaluation output for the plurality of records in parallel.

14. The method of claim 1, wherein the holistic analysis further comprises proposing a modification to a configuration parameter of the multi stage AI pipeline and the method further comprises:
automatically parsing the at least one recommendation to identify the proposed modification to the configuration parameter; and
programmatically modifying the configuration parameter of the multi-stage AI pipeline based on the identified modification, thereby creating a modified multi-stage AI pipeline.

15. The method of claim 14, wherein the multi-stage AI pipeline is a RAG (Retrieval-Augmented Generation) pipeline, and wherein the configuration parameter comprises a retrieval parameter (‘k’).

16. A system for evaluating a performance of a multi-stage AI pipeline, the system comprising: a memory that stores computer executable components; and a processor that executes the computer executable components stored in the memory, wherein the computer executable components comprise:
a metric calculator configured to generate a collection of evaluation outputs, one or more of which comprises a quantitative feedback and a qualitative feedback for a plurality of predefined AI pipeline evaluation metrics;
an insight generator configured to, for the plurality of predefined AI pipeline evaluation metrics, (i) generate at least one aggregated metric score and (ii) compile a natural language insight report; and
an action recommender configured to provide a set of actionable recommendations based on a holistic analysis of the natural language insight reports.

17. The system of claim 16, wherein one or more of the metric calculator, the insight generator, and the action recommender are communicatively coupled to one or more large language models and wherein (1) the metric calculator is further configured to cause a first large language model (LLM) to generate the evaluation outputs; (2) the insight generator is further configured to cause a second LLM to compile the natural language insight reports or (3) the action recommender is further configured to cause a third LLM to provide the set of actionable recommendations.

18. The system of claim 17, wherein the second LLM is a specialized reasoning LLM.

19. The system of claim 17, wherein the third LLM is a reasoning LLM.

20. The system of claim 16, further comprising an action prioritizer configured to prioritize the set of actionable recommendations based on an impact on system performance, the impact on system performance comprising at least a high impact level and a medium impact level.
